(19) United States
(12) Patent Application Publication
(10) Pub. No.: US 2023/0169893 A1
(43) Pub. Date: Jun. 1, 2023

(54) Modular Art Display Assembly

(71) Applicant: Charles Blackwell, San Antonio, TX (US)

(72) Inventor: Charles Blackwell, San Antonio, TX (US)

(21) Appl. No.: 17/539,897

(22) Filed: Dec. 1, 2021

(51) Int. Cl. G09F 7/10; G09F 7/18

(52) U.S. Cl. CPC G09F 7/10; G09F 7/18; G09F 2007/1843

(57) ABSTRACT

A modular art display assembly includes a frame that has a plurality of intersecting members such that the frame has a rectangular shape. Each of the interesting members has a plurality of channels each is integrated into the intersecting members. The plurality of interesting members includes a hinged member which is hingedly coupled to a respective one of the intersecting members for opening and closing the frame. A plurality of structured elements is provided an each of the structured elements is insertable into respective channels in the intersecting members of the frame. In this way the structured elements are interlaced with each other in the frame to define an artistic expression for viewing pleasure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to art display devices and more particularly pertains to a new art display device for facilitating a user to create custom artistic expressions. The device includes a frame which has a plurality of channels integrated into the frame. Additionally, the frame includes a hinged member for opening and closing the frame. The device includes a plurality of structured elements that each has a unique shape with respect to each other. Each of the structured elements can be inserted into a respective channel and arranged into a variety of orientations to displaying a variety of artistic expressions

### (2) Description of Related Art Including Information Disclosed Under 37 CFR 1.97 and 1.98

The prior art relates to art display devices including an artistic display device that includes a frame and a plurality of interchangeable tiles being integrated into the frame. The prior art discloses a puzzle device which as a frame and a plurality of slidable tiles each being integrated into the frame. The prior art discloses a modular picture frame for displaying a completed jig saw puzzle. The prior art discloses a decorative backsplash device that includes a frame that can be integrated into a wall for surrounding an opening in the wall and a decorative panel that is removably attachable to the frame for concealing the opening. The prior art discloses an interchangeable tile device for facilitating a plurality of tiles to be interchanged with each other in a plurality of layers for displaying a variety of artistic expressions.

### BRIEF SUMMARY OF THE INVENTION

An embodiment of the disclosure meets the needs presented above by generally comprising a frame that has a plurality of intersecting members such that the frame has a rectangular shape. Each of the interesting members has a plurality of channels each is integrated into the intersecting members. The plurality of interesting members includes a hinged member which is hingedly coupled to a respective one of the intersecting members for opening and closing the frame. A plurality of structured elements is provided an each of the structured elements is insertable into respective channels in the intersecting members of the frame. In this way the structured elements are interlaced with each other in the frame to define an artistic expression for viewing pleasure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a modular art display assembly according to an embodiment of the disclosure.

FIG. 2 is a front view of an embodiment of the disclosure.

FIG. 3 is an exploded perspective view of an embodiment of the disclosure.

FIG. 4 is a back exploded view of an embodiment of the disclosure.

FIG. 5 is a cross sectional view taken along line 5-5 of FIG. 4 of an embodiment of the disclosure.

FIG. 6 is a perspective view of an alternative embodiment of the disclosure.

### DETAILED DESCRIPTION OF THE INVENTION

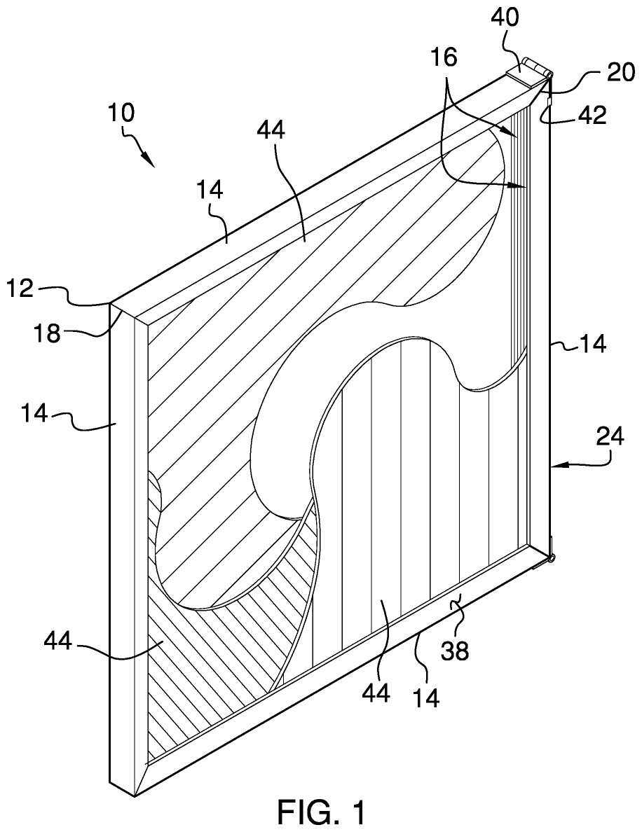

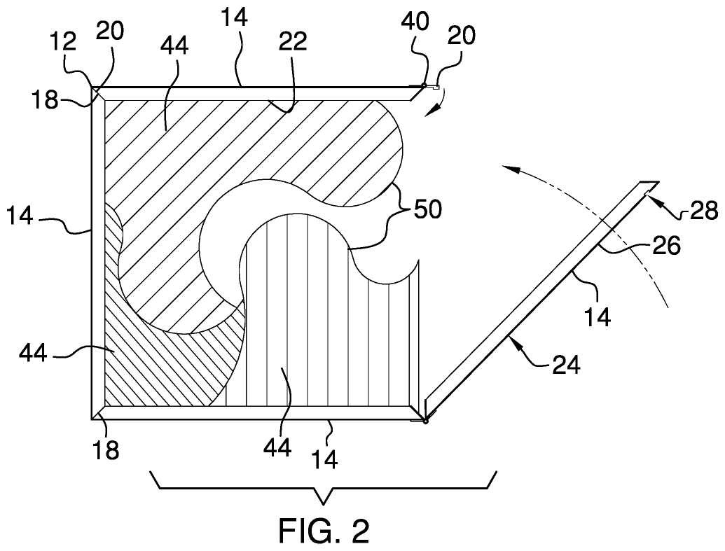

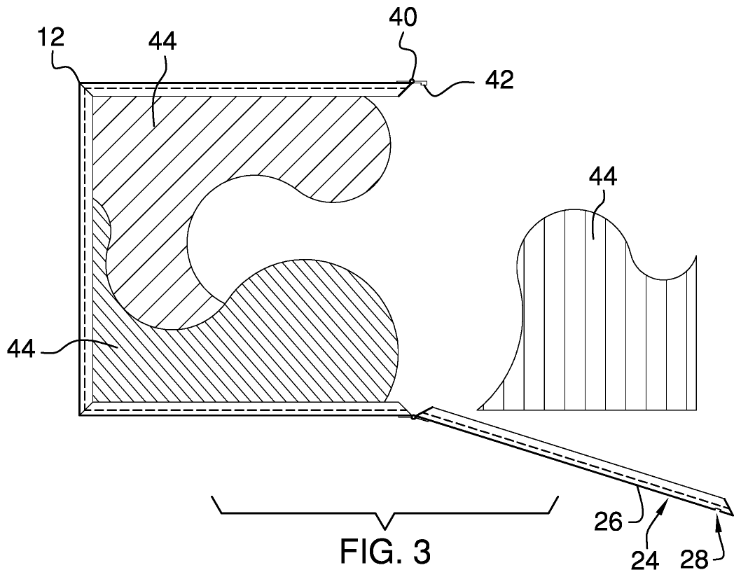

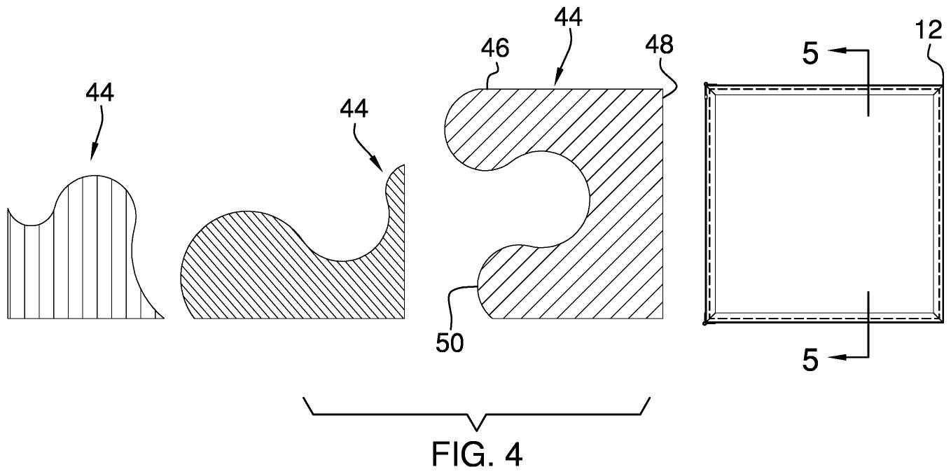

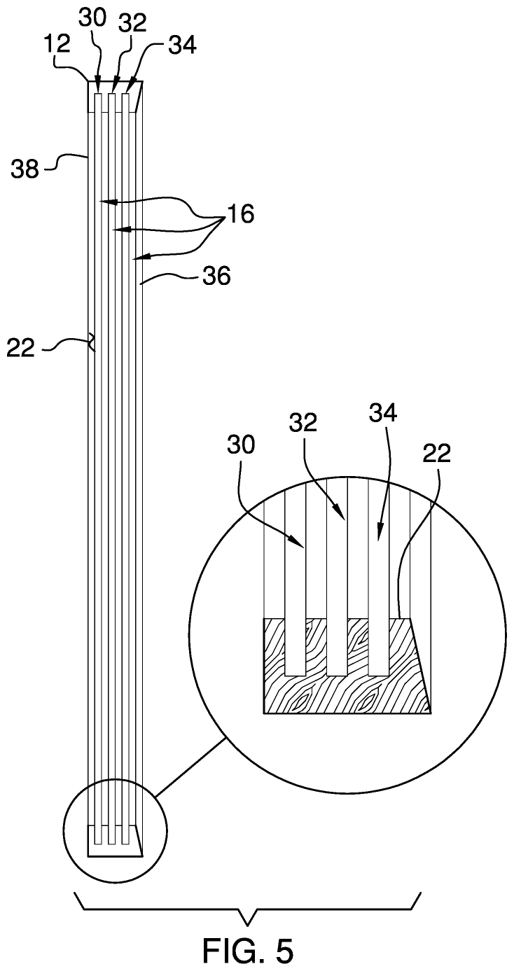

With reference now to the drawings, and in particular to FIGS. 1 through 6 thereof, a new art display device embodying the principles and concepts of an embodiment of the disclosure and generally designated by the reference numeral 10 will be described.

As best illustrated in FIGS. 1 through 6, the modular art display assembly 10 generally comprises a frame 12 which has a plurality of intersecting members 14 such that the frame 12 has a rectangular shape. Each of the interesting members 14 has a plurality of channels 16 that is each integrated into the intersecting members 14, and the channels 16 are oriented parallel to each other. Each of the intersecting members 14 has a first end 18, a second end 20 and a first surface 22 extending between the first end 18 and the second end 20. Additionally, each of the first end 18 and the second end 20 of each of the intersecting members 14 is oriented at an obtuse outside angle with the first surface 22 of a respective intersecting member 14. The first end 18 of each of the intersecting members 14 engages the second end 20 of a respective intersecting member 14.

The plurality of interesting members 14 includes a hinged member 24 which is hingedly coupled to a respective one of the intersecting members 14. The hinged member 24 is positionable in a closed position having the frame 12 defining the rectangular shape. Conversely, the hinged member 24 is positionable in an open position having the hinged member 24 angling away from the respective intersecting member 14. The first end 18 of the hinged member 24 is hingedly coupled to the second end 20 of a respective intersecting member 14. Additionally, the hinged member 24 has a second surface 26 extending between the first end 18 and the second end 20 of the hinged member 24, and the second surface 26 has an engagement point 28 that is located adjacent to the second end 20 of the hinged member 24.

Each of the channels 16 is recessed into the first surface 22 of the respective intersecting member 14. Each of the channels 16 extends between the first end 18 and the second end 20 of the respective intersecting member 14. The plurality of channels 16 includes a set of first channels 30, a set of second channels 32 and a set of third channels 34. Each of the first channels 30 is aligned with each other in each of the intersecting members 14, each of the second channels 32 is aligned with each other in each of the intersecting members 14, and each of the third channels 34 is aligned with each other in each of the intersecting members 14. Each of the intersecting members 14 includes a front surface 36 and a rear surface 38. The first channels 30, the second channels 32 and the third channels 34 are distributed between the front surface 36 and the rear surface 38. Additionally, the front surface 36 of each of the intersecting members 14

An engagement 40 is movably attached to a respective one of the intersecting members 14. The engagement 40 is positioned adjacent to the first end 18 of the interesting member to which the engagement 40 is movably attached. Furthermore, the engagement 40 releasably engages the engagement point 28 on the second surface 26 of the hinged member 24 when the hinged member 24 is positioned in the closed position. In this way the hinged member 24 is retained in the closed position. The engagement 40 may comprise a finger 42 that is pivotally disposed on the respective intersecting member 14. The engagement point 28 may comprise an indentation, a loop, a receiver or any other type of element that can insertably receive the finger 42 when the hinged member 24 is in the closed position.

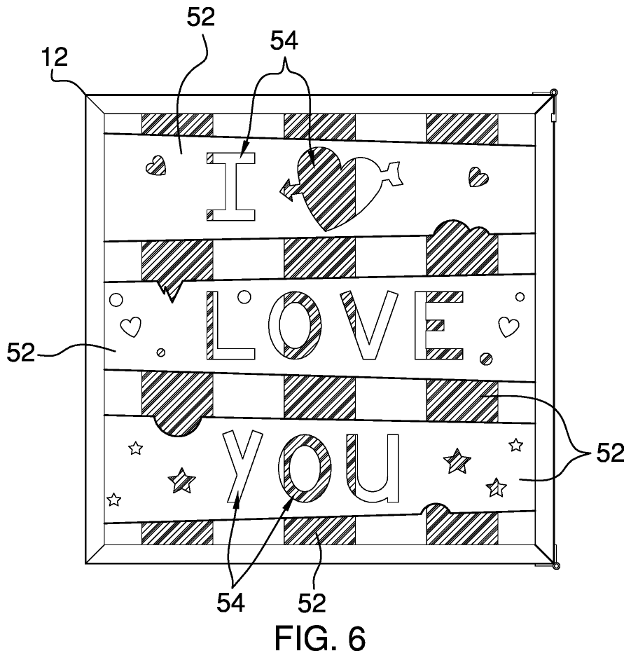

A plurality of structured elements 44 is provided and each of the structured elements 44 is insertable into respective channels 16 in the intersecting members 14 of the frame 12. In this way the structured elements 44 are interlaced with each other in the frame 12 to define an artistic expression for viewing pleasure. Each of the structured elements 44 has an outer edge 46 and the outer edge 46 of each of the structured elements 44 has at least one engaging side 48 for slidably engaging a respective one of the first channels 30, the second channels 32 or the third channels 34 in a respective one of the intersecting members 14 of the frame 12. Furthermore, the outer edge 46 of each of the structured elements 44 includes an undulating side 50 that is exposed when the structured elements 44 is positioned in the respective channel. In this way the undulating side 50 is visible in the frame 12. The undulating side 50 of the outer edge 46 of each of the structured elements 44 may define a unique series of curves, lobes and depressions. As is most clearly shown in FIG. 6, the plurality of structured elements 44 may include a plurality of elongated panels 52 which each has a plurality of openings 54 extending through the elongated panels 52 that are structured to resemble letters of the English alphabet. In this way the elongated panels 52 can be combined in a variety of configurations to communicate various phrases.

In use, the hinged member 24 is positioned in the open position and respective ones of the structured elements 44 are inserted into respective channels 16 in the frame 12. The hinged member 24 is positioned in the closed position to retain the structured elements 44 in the frame 12 and the engagement 40 is manipulated to engage the engagement point 28. In this way the structured elements 44 can be arranged in the frame 12 for displaying one of a variety of possible artistic expressions. Additionally, the structured elements 44 can be continually re-arranged in the frame 12, depending on the user's preferences.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular art display assembly having a plurality of interchangeable elements for facilitating a variety of artistic expressions, said assembly comprising:
a frame having a plurality of intersecting members such that said frame has a rectangular shape, each of said interesting members having a plurality of channels each being integrated into said intersecting members, said channels being oriented parallel to each other, said plurality of interesting members including a hinged member being hingedly coupled to a respective one of said intersecting members, said hinged member being positionable in a closed position having said frame defining said rectangular shape, said hinged member being positionable in an open position having said hinged member angling away from said respective intersecting member; and
a plurality of structured elements, each of said structured elements being insertable into respective channels in said intersecting members of said frame such that each of said structured elements is interlaced with each other in said frame wherein said structured elements are configured to define an artistic expression for viewing pleasure.

2. The assembly according to claim 1, wherein:
each of said intersecting members has a first end, a second end and a first surface extending between said first end and said second end, each of said first end and said second end of each of said intersecting members being oriented at an obtuse outside angle with said first surface of a respective intersecting member, said first end of each of said intersecting members engaging said second end of a respective intersecting member; and
said first end of said hinged member is hingedly coupled to said second end of a respective intersecting member.

3. The assembly according to claim 2, wherein each of said channels is recessed into said first surface of said respective intersecting member, each of said channels extending between said first end and said second end of said respective intersecting member.

4. The assembly according to claim 1, wherein said plurality of channels includes a set of first channels, a set of second channels and a set of third channels, each of said first channels being aligned with each other in each of said intersecting members, each of said second channels being aligned with each other in each of said intersecting members, each of said third channels being aligned with each other in each of said intersecting members.

5. The assembly according to claim 2, wherein:
said hinged member has a second surface extending between said first end and said second end of said hinged member, said second surface having an engagement point being located adjacent to said second end of said hinged member; and
said assembly includes an engagement being movably attached to a respective one of said intersecting members, said engagement being positioned adjacent to said first end of said interesting member to which said engagement is movably attached, said engagement releasably engaging said engagement point on said second surface of said hinged member when said hinged member is positioned in said closed position for retaining said hinged member in said closed position.

6. The assembly according to claim 4, wherein each of said structured elements has an outer edge, said outer edge of each of said structured elements having at least one engaging side for slidably engaging a respective one of said first channels, said second channels or said third channels in a respective one of said intersecting members of said frame, said outer edge of each of said structured elements including a undulating side being exposed when said structured elements is positioned in said respective channel wherein said undulating side is configured to be visible in said frame.

7. A modular art display assembly having a plurality of interchangeable elements for facilitating a variety of artistic expressions, said assembly comprising:
a frame having a plurality of intersecting members such that said frame has a rectangular shape, each of said interesting members having a plurality of channels each being integrated into said intersecting members, said channels being oriented parallel to each other, each of said intersecting members having a first end, a second end and a first surface extending between said first end and said second end, each of said first end and said second end of each of said intersecting members being oriented at an obtuse outside angle with said first surface of a respective intersecting member, said first end of each of said intersecting members engaging said second end of a respective intersecting member, said plurality of interesting members including a hinged member being hingedly coupled to a respective one of said intersecting members, said hinged member being positionable in a closed position having said frame defining said rectangular shape, said hinged member being positionable in an open position having said hinged member angling away from said respective intersecting member, said first end of said hinged member being hingedly coupled to said second end of a respective intersecting member, said hinged member having a second surface extending between said first end and said second end of said hinged member, said second surface having an engagement point being located adjacent to said second end of said hinged member, each of said channels being recessed into said first surface of said respective intersecting member, each of said channels extending between said first end and said second end of said respective intersecting member, said plurality of channels including a set of first channels, a set of second channels and a set of third channels, each of said first channels being aligned with each other in each of said intersecting members, each of said second channels being aligned with each other in each of said intersecting members, each of said third channels being aligned with each other in each of said intersecting members;
an engagement being movably attached to a respective one of said intersecting members, said engagement being positioned adjacent to said first end of said interesting member to which said engagement is movably attached, said engagement releasably engaging said engagement point on said second surface of said hinged member when said hinged member is positioned in said closed position for retaining said hinged member in said closed position; and
a plurality of structured elements, each of said structured elements being insertable into respective channels in said intersecting members of said frame such that each of said structured elements is interlaced with each other in said frame wherein said structured elements are configured to define an artistic expression for viewing pleasure, each of said structured elements having an outer edge, said outer edge of each of said structured elements having at least one engaging side for slidably engaging a respective one of said first channels, said second channels or said third channels in a respective one of said intersecting members of said frame, said outer edge of each of said structured elements including a undulating side being exposed when said structured elements is positioned in said respective channel wherein said undulating side is configured to be visible in said frame.
